(19) United States
(12) Patent Application Publication
(10) Pub. No.: US 2009/0083514 A1
(43) Pub. Date: Mar. 26, 2009

(54) APPARATUS AND METHOD FOR BLOCK INTERLEAVING IN MOBILE COMMUNICATION SYSTEM

(76) Inventors: Bo-Rham LEE, Seoul (KR); Jong-Hun Rhee, Suwon-si (KR); Min-Goo Kim, Hwaseong-si (KR); In-Tae Kang, Seongnam-si (KR); Jun-Kyu Kang, Seoul (KR)

Correspondence Address: CHA & REITER, LLC, 210 ROUTE 4 EAST STE 103, PARAMUS, NJ, 07652, US

(21) Appl. No.: 12/234,788

(22) Filed: Sep. 22, 2008

(30) Foreign Application Priority Data
Sep. 20, 2007 (KR) 2007-0095628

(51) Int. Cl. G06F 12/06

(52) U.S. Cl. 711/221; 711/200; 711/E12.079

(57) ABSTRACT

A method and apparatus for block interleaving that eliminates the step of intermediary buffering. The method includes: (a) calculating a memory address at which first output data, of which number is equal to the number of rows of a first encoder is stored, (b) storing the first output data at the calculated memory address of a circular buffer, (c) storing second output data at an address which is incremented by a specific constant value from the calculated memory address of the circular buffer, and (d) storing (n+1)^{th} output data at an address which is incremented by n from the calculated memory address of the circular buffer.

### CLAIM OF PRIORITY

This application claims the benefit under 35 U.S.C. § 119(a) from a Korean patent application filed in the Korean Intellectual Property Office on Sep. 20, 2007 and assigned Serial No. 2007-95628, the entire disclosure of which is hereby incorporated by reference in its entirety.

### BACKGROUND OF THE INVENTION

1. Field of the Invention

The present invention relates to techniques for improving/reducing the buffering occurring in a block interleaving system. More particularly, the present invention relates to an apparatus and method for block interleaving in a Long Term Evolution (LTE) communication system.

2. Description of the Related Art

Block interleaving is a technique of data transmission whereby data sequences are changed into a specific pattern (as opposed to continuous transmission of the data sequences), in order to reduce occurrence of burst errors (i.e., continuously generated errors).

FIG. 1 is a block diagram illustrating a structure of a conventional sub-block interleaving method.

Referring now to FIG. 1, in the conventional method, before a read-address controller 130 interleaves outputs of a turbo encoder 110, the encoder output values are stored in a plurality of buffers 120, 125, and 127.

The read-address controller 130 functions to interleave outputs of the plurality of buffers 120, 125, and 127 and then stores the interleaved outputs in circular buffers 140 and 145.

When using the conventional method as shown in FIG. 1, there are disadvantages in that the buffers 120, 125, and 127 are required to store the encoder output values.

In addition, since the encoder output values are stored in the buffers 120, 125, and 127 and then interleaving is performed according to the read address controller, there is an additional problem of a increased time delay.

### SUMMARY OF THE INVENTION

Accordingly, an exemplary aspect of the present invention is to provide an apparatus and method for block interleaving in a mobile communication system.

Another exemplary aspect of the present invention is to provide an apparatus and method for performing block interleaving without an intermediary buffer in a mobile communication system.

Another exemplary aspect of the present invention is to provide an apparatus and method for performing block interleaving without the inherent delay resulting from the use of an intermediary buffer in a mobile communication system.

In accordance with an exemplary embodiment of the present invention, a method for block interleaving includes: (a) calculating a memory address at which first output data, of which number is equal to the number of rows of a first encoder, is stored; (b) storing the first output data at the calculated memory address of a circular buffer; (c) storing second output data at an address which is incremented by a specific constant value from the calculated memory address of the circular buffer; and (d) storing (n+1)^{th} output data at an address which is incremented by n from the calculated memory address of the circular buffer.

In accordance with another exemplary embodiment of the present invention, an apparatus for block interleaving includes: an address controller for calculating a memory address at which first output data, of which number is equal to the number of rows of a first encoder is stored, for storing the first output data at the calculated memory address of a circular buffer, and for storing second output data at an address which is incremented by a specific constant value from the calculated memory address of the circular buffer, and for storing (n+1)^{th} output data at an address which is incremented by n from the calculated memory address of the circular buffer.

### BRIEF DESCRIPTION OF THE DRAWINGS

The above and other exemplary aspects, features and advantages of certain exemplary embodiments of the present invention will be more apparent from the following detailed description taken in conjunction with the accompanying drawings, in which:

FIG. 1 is a block diagram illustrating a structure of a conventional sub-block interleaving method;

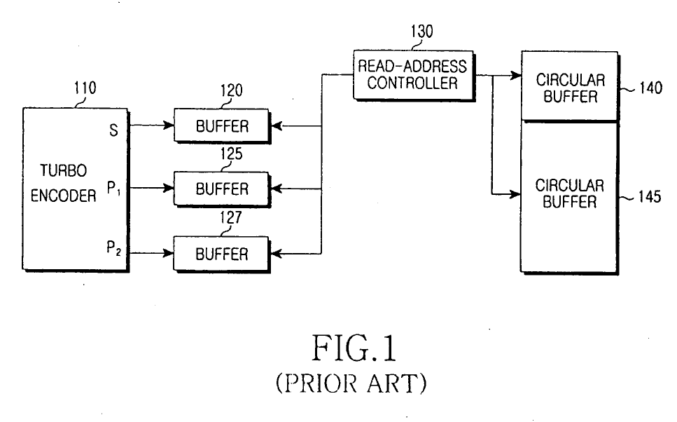

FIG. 2 is a flowchart illustrating a process of creating a table considering pruning according to an exemplary embodiment of the present invention;

FIG. 3 is a flowchart illustrating a process of operating sub-block interleaving according to an exemplary embodiment of the present invention; and

FIG. 4 is a block diagram for sub-block interleaving according to an exemplary embodiment of the present invention.

### DETAILED DESCRIPTION

Exemplary embodiments of the present invention will be described below with reference to the accompanying drawings. For the purposes of clarity and simplicity, well-known functions or constructions may not be described in detail as they would obscure appreciation of the present invention by a person of ordinary skill in the art with unnecessary detail.

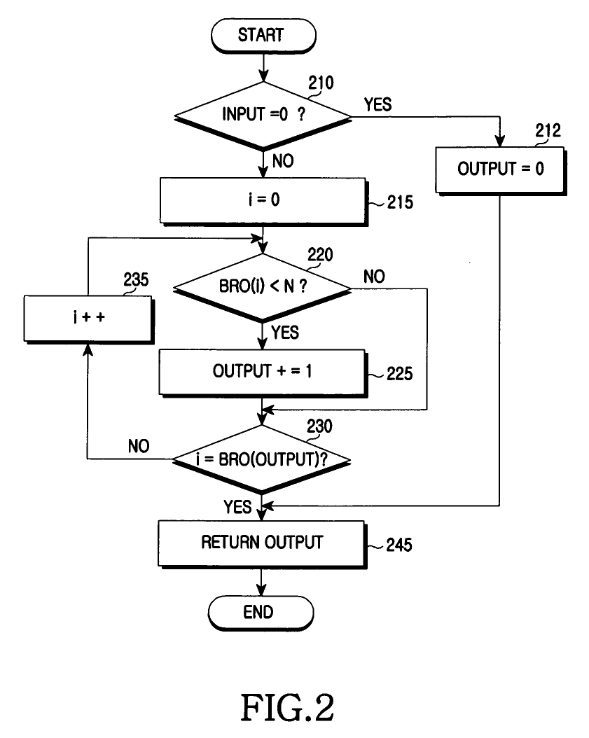

Hereinafter, an apparatus and method for block interleaving in a mobile communication system will be described in conjunction with FIGS. 2, 3 and 4. In a brief overview, it will be assumed that a 32-bit column is used for interleaving in the present invention.

According to one exemplary aspect of the present invention, among all inputs, only an address of first unit data (i.e., values filled in a first row of a block interleaver) output from an encoder is calculated and stored in a circular buffer.

Second unit data is stored in the circular buffer according to an address which is incremented by +1 from the address of first unit data. That is, subsequent output addresses are recursively obtained.

Accordingly, without having to perform complex calculations to obtain all address values, subsequent address values can be easily obtained after calculating the address of the first unit data to be stored in the circular buffer.

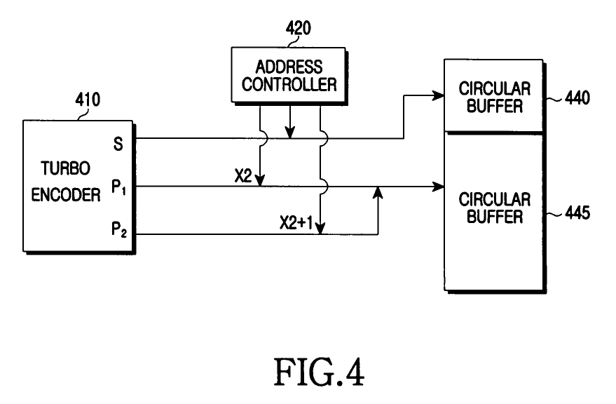

The encoder of the present invention may comprise, for example, a turbo encoder 140, an example of which is shown in FIG. 4. An output format of the turbo encoder is predetermined, and as a result, pruning is also determined.

In case of 3rd Generation Partnership Project Long Time Evolution (3GPP LTE), if a column length of the output format is 32 bits, four types of pruning are determined. The four types of pruning are created and stored in the format of a table according to the procedure to be described below. Values to be used are loaded from the table.

Now referring to FIG. 2, which is a flowchart illustrating a process of creating a table considering pruning according to an exemplary embodiment of the present invention, inputs of the process are input numbers from 0 to 31 included in unit data. N denotes a pruning number (indicating any one of four types of pruning). In addition, an output of the process is the number of shifts.

First, at step 210, it is determined whether an input value is 0.

If the input value is 0, then at step 212, an output value is determined to 0, and the output value is returned in step 245.

Otherwise, if the input value is not 0, at step 215, a local variable i is determined to 0. Thereafter, if a value of Bit Reverse Ordering (BRO) (i) is less than N in step 220, the output value is incremented by 1 in step 225. The BRO( ) denotes a 5-bit reverse ordering number depending on the input value. For example, since a hexadecimal format of 5 is ‘00101’, the result of BRO [5] is ‘10100’ (=20), that is, BRO [5]=20.

If a value of BRO (output) is equal to the local variable i in step 230, the output value in step 225 is returned in step 245.

Otherwise, if the value of BRO (output) is different from the location variable i in step 230, the local variable i is incremented by 1, and step 220 and subsequent steps from the step of 220 are repeated.

The above procedure is repeated with respect to all input numbers from 0 to 31.

A process that considers pruning is performed using the output values as shift values. After ending the procedure of FIG. 2, an address value to be stored in the circular buffer is calculated. The address value is for first unit data to be interleaved and stored. The address value is calculated according to Equation (1) below.

Addr[i]=BRO[i%32]*N_row−Pruning[i%32] Equation (1)

In Equation (1), i denotes an input ordering number. Addr[i] denotes an address to be stored. BRO[ ] denotes a 5-bit reverse ordering number depending on the input value. For example, since a hexadecimal format of 5 is ‘00101’, the result of BRO[5] is ‘10100’ (=20), that is, BRO[5]=20. Pruning[ ] is a value obtained by calculating a pruning number in a storage region according to an input address. N_row represents ceil(N/32), and is a value obtained by dividing an input size by a unit data number (i.e., 32).

When an address of the first unit data is generated, respective encoder outputs in subsequent unit data are generated by adding +1 to previously calculated 32 address values. All encoder outputs are thus processed in this manner, and sub-block interleaved data is stored in the circular buffer.

If it is assumed that outputs of the turbo encoder are generated by receiving them when the address of the first unit data is generated, then the following three address types can be required. The three address types can be obtained according to Equation (2) below.

for outputs of a systematic node,

Addr[i]=BRO[i%32]*N_row−Pruning[i%32] Equation (2)

For the outputs of systematic node, Equation (2) is identical to the Equation (1).

In Equation (2), i denotes an output ordering number. Addr[i] denotes an address to be stored. BRO[ ] denotes a 5-bit reverse ordering number depending on the input value. For example, since a hexadecimal format of 5 is ‘00101’, the result of BRO[5] is ‘10100’ (=20), that is, BRO[5]=20. Pruning[ ] is a value obtained by calculating a pruning number in a storage region according to an input address. N_row represents ceil(N/32), and is a value obtained by dividing an input size by a unit data number (i.e., 32).

for outputs of a parity 1 node,

Addr[i]=2*(BRO[i%32]*N_row)−Pruning[i%32]

Herein, i denotes an input ordering number. Addr[i] denotes an address to be stored. BRO[ ] denotes a 5-bit reverse ordering number depending on the input value. For example, since a hexadecimal format of 5 is ‘00101’, the result of BRO[5] is ‘10100’ (=20), that is, BRO[5]=20. Pruning[ ] is a value obtained by calculating a pruning number in a storage region according to an input address. N_row represents ceil(N/32), and is a value obtained by dividing an input size by a unit data number (i.e., 32).

For outputs of a parity 2 node,

Addr[i]=2*(BRO[i%32]*N_row)−Pruning[i%32]

Herein, i denotes an input ordering number. Addr[i] denotes an address to be stored. BRO[ ] denotes a 5-bit reverse ordering number depending on the input value. For example, since a hexadecimal format of 5 is ‘00101’, the result of BRO[5] is ‘10100’ (=20), that is, BRO[5]=20. Pruning[ ] is a value obtained by calculating a pruning number in a storage region according to an input address. N_row represents ceil(N/32), and is a value obtained by dividing an input size by a unit data number (i.e., 32).

An (n+1) address for an output of each of the parity 1 node and the parity 2 node is obtained by adding 2 to the calculated addressed stored in the storage buffer.

According to the address calculated according to the first unit data, an output of the turbo encoder is stored in the circular buffer.

Subsequent unit data is stored in the circular buffer according to addresses which are incremented by +1 or +2 from 32 first addresses. That is, subsequent output addresses are recursively obtained.

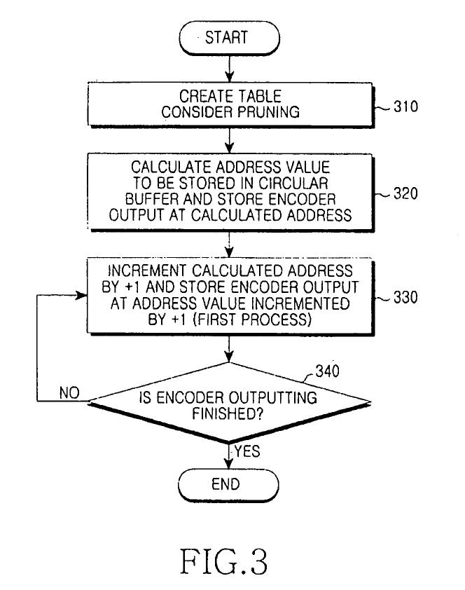

FIG. 3 is a flowchart illustrating a process of operating sub-block interleaving according to an exemplary embodiment of the present invention.

Referring now to FIG. 3, a table is created according to the procedure of FIG. 2 by considering a unit data number and pruning (step 310). This step is performed only one time.

By using an address value calculated using Equation (2) above, an output of a turbo encoder is stored in a circular buffer (step 320). In this particular case, 32 address values are first calculated.

By using an address value which is incremented by +1 from the address value obtained in step 320, the output of the turbo encoder is stored in the circular buffer in step 330 (referred to as a first process). The first process is repeated until outputting of the turbo encoder is finished (step 340).

FIG. 4 is a block diagram for sub-block interleaving according to an exemplary embodiment of the present invention.

Referring now to FIG. 4, values output from a Systematic (S) node, a Parity 1 (P1) node, and a Parity 2 (P2) node of a turbo encoder 410 are block-interleaved by an address controller 420, and then are stored in circular buffers 440 and 445.

According to this particularly exemplary embodiment in FIG. 4, a value output from the S node of the turbo encoder 410 is stored in the circular buffer 440. Values output from the P1 and P2 nodes of the turbo encoder 410 are alternately stored in the circular buffer 450. An address, at which the output value of the P1 node is stored, is obtained by multiplying 2 by an address at which the output value of the S node. An address, at which the output value of the P2 node is stored, is obtained by adding 1 to an address at which the output value of the P1 node is stored.

The address controller 420 calculates 32 address values of first unit data (i.e., values output from the turbo encoder and filled in a first row of a block interleaver) by using a table considering pruning. The address values are incremented by +1 to obtain subsequent address values. The obtained address values are stored in the circular buffers 440 and 445.

According to exemplary embodiments of the present invention, a hardware structure can be simplified by eliminating an intermediary buffer. In addition, a time delay can be reduced by omitting operations that require the use of the intermediary buffer.

While the present invention has been shown and described with reference to certain exemplary embodiments thereof in the description, it will be understood by those skilled in the art that various changes in form and details may be made therein without departing from the spirit and scope of the present invention as defined by the appended claims.

What is claimed is:

1. A method for block interleaving without an intermediary buffer, comprising:
(a) calculating a memory address of a circular buffer at which a first output data, of which number is equal to a number of rows of a first encoder, is to be stored;
(b) storing the first output data at the calculated memory address from step (a) of the circular buffer;
(c) storing a second output data at an address which comprises the calculated memory address of the circular buffer being changed by a specific constant value; and
(d) storing (n+1)^{th} output data at an address which is incremented by n from the calculated memory address of the circular buffer.

2. The method of claim 1, wherein the second output data address comprises is incremented by the specific constant value.

3. The method of claim 1, further comprising, before the calculating of the memory address in step (a), creating a table for determining the first output data number and for considering pruning of the number.

4. The method of claim 3, wherein the creating of the table comprises:
(i) determining whether an input value is 0;
if the input value is 0, determining an output value to 0 and returning the output value;
if the input value is not 0, determining a local variable i to 0;
after the determining of the local variable i to 0, if a value of output permutation(i) is less than N, incrementing the output value by 1;
after the incrementing of the output value by 1, if the value of output permutation(output) is equal to the local variable i, returning the output value;
if the value of output permutation(output) is not equal to the local variable i, incrementing the local variable i by 1, return to the step of determining whether the value of output permutation(output) is less than N; and
(ii) repeating the creating of the table with respect to all input numbers so that pruning is considered using output values as shift values,
wherein the output permutation(i) denotes a 5-bit reverse ordering number, for example, when using BRO( ), the output permutation(i) is a reverse ordering number (e.g., since a hexadecimal format of 5 is ‘00101’, the result of BRO[5] is ‘10100’ (=20), that is, BRO[5]=20), wherein inputs of the calculation process are input numbers 0 to 31 included in unit data, wherein N denotes a pruning number (indicating any one of four types of pruning), and wherein an output of the calculation process is the number of shifts.

5. The method of claim 1, wherein the calculated memory address is expressed by:
Addr[i]=BRO[i%32]*N_row−Pruning[i%32],
where i denotes an input ordering number, Addr[i] denotes an address to be stored, BRO[ ] denotes a 5-bit reverse ordering number depending on an input value, Pruning[ ] is a value obtained by calculating a pruning number in a storage region according to an input address, and N_row is a value obtained by dividing an input size by a unit data number.

6. The method of claim 1, wherein, if the first encoder comprises a turbo encoder, the calculated memory address for an output of a systematic node is expressed by:
Addr[i]=BRO[i%32]*N_row−Pruning[i%32],
where i denotes an input ordering number, Addr[i] denotes an address to be stored, BRO[ ] denotes a 5-bit reverse ordering number depending on the input value, Pruning[ ] is a value obtained by calculating a pruning number in a storage region according to an input address, and N_row is a value obtained by dividing an input size by a unit data number.

7. The method of claim 1, wherein the first encoder comprises a turbo encoder.

8. The method of claim 1, wherein, if the first encoder comprises a turbo encoder, the calculated memory address for an output of a parity 1 node is expressed by:
Addr[i]=2*(BRO[i%32]*N_row)−Pruning[i%32],
where i denotes an input ordering number, Addr[i] denotes an address to be stored, BRO[ ] denotes a 5-bit reverse ordering number depending on an input value, Pruning[ ] is a value obtained by calculating a pruning number in a storage region according to an input address, and N_row is a value obtained by dividing an input size by a unit data number.

9. The method of claim 1, wherein, if the first encoder comprises a turbo encoder, the calculated memory address for an output of a parity 2 node is expressed by:
Addr[i]=2*(BRO[i%32]*N_row)−Pruning[i%32]
where i denotes an input ordering number, Addr[i] denotes an address to be stored, BRO[ ] denotes a 5-bit reverse ordering number depending on the input value, that is, BRO[5]=20), Pruning[ ] is a value obtained by calculating a pruning number in a storage region according to an input address, and N_row is a value obtained by dividing an input size by a unit data number.

10. An apparatus for block interleaving without an intermediary buffer, comprising:
a first encoder for outputting encoded data values for block interleaving;
a circular buffer for storing the values output from the first encoder; and
an address controller for block interleaving and for (i) calculating a memory address of the circular buffer at which a first output encoded data value is stored, of which number is equal to a number of rows of the first encoder, and (ii) for storing the first output data at the calculated memory address of the circular buffer, and (iii) for storing second output data at an address which is incremented by a specific constant value from the calculated memory address of the circular buffer, and (iv) for storing (n+1)^{th} output data at an address which is incremented by n from the calculated memory address of the circular buffer.

11. The apparatus of claim 10, wherein, before the calculating of the memory address, the address controller includes table creation means for considering the first output data number and pruning.

12. The apparatus of claim 11, wherein the address controller further includes means for:
determining whether an input value is 0,
if the input value is 0, determining an output value to 0 and returning the output value,
if the input value is not 0, determining a local variable i to 0,
after the determining of the local variable i to 0, if a value of output permutation(i) is less than N, incrementing the output value by 1,
after the incrementing of the output value by 1, if the value of output permutation(output) is equal to the local variable i, returning the output value,
if the value of output permutation(output) is not equal to the local variable i, incrementing the local variable i by 1, return to the step of determining whether the value of output permutation(output) is less than N, and
repeating the creating of the table with respect to all input numbers so that pruning is considered using output values as shift values,
wherein the output permutation(i) denotes a 5-bit reverse ordering number, for example, when using BRO( ), the output permutation(i) comprises a reverse ordering number, wherein inputs of the calculation process comprise input numbers 0 to 31 included in unit data, wherein N denotes a pruning number indicating a type of pruning, and wherein an output of the calculation process comprises the number of shifts.

13. The apparatus of claim 10, wherein the calculated memory address is expressed by:
Addr[i]=BRO[i%32]*N_row−Pruning[i%32],
where i denotes an input ordering number, Addr[i] denotes an address to be stored, BRO[ ] denotes a 5-bit reverse ordering number depending on the input value, Pruning[ ] is a value obtained by calculating a pruning number in a storage region according to an input address, and N_row is a value obtained by dividing an input size by a unit data number.

14. The apparatus of claim 10, wherein, if the first encoder comprises a turbo encoder, the calculated memory address for an output of a systematic node is expressed by:
Addr[i]=BRO[i%32]*N_row−Pruning[i%32],
where i denotes an input ordering number, Addr[i] denotes an address to be stored, BRO[ ] denotes a 5-bit reverse ordering number depending on the input value, Pruning[ ] is a value obtained by calculating a pruning number in a storage region according to an input address, and N_row representing ceil is a value obtained by dividing an input size by a unit data number.

15. The apparatus of claim 10, wherein, if the first encoder comprises a turbo encoder, the calculated memory address for an output of a parity 1 node is expressed by:
Addr[i]=2*(BRO[i%32]*N_row)−Pruning[i%32]
where i denotes an input ordering number, Addr[i] denotes an address to be stored, BRO[ ] denotes a 5-bit reverse ordering number depending on the input value, that is, BRO[5]=20), Pruning[ ] is a value obtained by calculating a pruning number in a storage region according to an input address, and N_row is a value obtained by dividing an input size by a unit data number.

16. The apparatus of claim 10, wherein, if the first encoder comprises a turbo encoder, the calculated memory address for an output of a parity 2 node is expressed by:
Addr[i]=2*(BRO[i%32]*N_row)−Pruning[i%32]
where i denotes an input ordering number, Addr[i] denotes an address to be stored, BRO[ ] denotes a 5-bit reverse ordering number depending on the input value, Pruning[ ] is a value obtained by calculating a pruning number in a storage region according to an input address, and N_row is a value obtained by dividing an input size by a unit data number.

17. The apparatus according to claim 10, wherein the values output from the first encoder comprise values output from a Systematic (S) node, a Parity 1 (P1) node, and a Parity 2 (P2) are block-interleaved by the address controller for storage are stored in the circular buffer.

18. The apparatus according to claim 10, wherein the circular buffer comprises a plurality of circular buffers.
